(19) United States
(12) Patent Application Publication
(10) Pub. No.: US 2021/0013483 A1
(43) Pub. Date: Jan. 14, 2021

(54) BATTERY ASSEMBLY, BATTERY, LID AND CASE

(71) Applicant: KABUSHIKI KAISHA TOSHIBA, Minato-ku (JP)

(72) Inventors: MASAMITSU URUNO, KASHIWAZAKI (JP); Kazuhiro TERAGUCHI, Kashiwazaki (JP); Yoshio TAKENOUCHI, Kashiwazaki (JP); Eiki KASHIWAZAKI, Kashiwazaki (JP)

(73) Assignee: KABUSHIKI KAISHA TOSHIBA, Minato- ku (JP)

(21) Appl. No.: 16/979,445

(22) PCT Filed: Mar. 29, 2018
(86) PCT No.: PCT/JP2018/013380

§ 371 Date: Sep. 9, 2020

(51) Int. Cl. H01M 2/36; H01M 2/12; H01M 2/30

(52) U.S. Cl. CPC H01M 2/36; H01M 2/30; H01M 2/12

(57) ABSTRACT

A battery assembly has no electrolytic solution injected. The battery assembly includes a housing, an electrode, a pressure release valve, and a liquid inlet. The housing houses the electrolytic solution, and includes a first wall to which an external connection terminal is exposed, and a second wall intersecting with the first wall. The electrode is housed in the housing and electrically connected to the external connection terminal. The pressure release valve is located in the first wall or the second wall, and to be opened in response to a rise in pressure inside the housing. The liquid inlet is separately provided from the pressure release valve in at least one of the first wall and the second wall. The liquid inlet includes a fragile part, to open an inside of the housing by breaking the fragile part to allow injection of the electrolytic solution.

### TECHNICAL FIELD

Embodiments of the present invention relate to a battery assembly, a battery, a lid, and a case.

### BACKGROUND ART

Conventionally, batteries are known, which include a housing having a first wall to which external connection terminals are exposed, and an electrode housed in the housing. The first wall is provided with a pressure release valve and a liquid inlet from which an electrolytic solution is injected.

### CITATION LIST

### Patent Literature

Patent Document 1: Japanese Laid-open Patent Application Publication No. 2015-76293

### SUMMARY OF INVENTION

### Problem to be Solved by the Invention

It is preferable to provide an improved battery assembly with a novel structure and less inconvenience, for example.

### Means for Solving Problem

According to one embodiment, for example, a battery assembly has no electrolytic solution injected. The battery assembly includes a housing, an electrode, a pressure release valve, and a liquid inlet. The housing can house the electrolytic solution, and includes a first wall to which an external connection terminal is exposed, and a second wall intersecting with the first wall. The electrode is housed in the housing and electrically connected to the external connection terminal. The pressure release valve is located in the first wall or the second wall, and to be opened in response to a rise in pressure inside the housing. The liquid inlet is separately provided from the pressure release valve in at least one of the first wall and the second wall. The liquid inlet includes a fragile part, to open an inside of the housing by breaking the fragile part to allow injection of the electrolytic solution.

### BRIEF DESCRIPTION OF DRAWINGS

FIG. 1 is an exemplary exploded perspective view of a battery of a first embodiment;

FIG. 2 is an exemplary and schematic cross-sectional view of a lid of the battery of the first embodiment;

FIG. 3 is an exemplary flowchart of a method for manufacturing the battery of the first embodiment;

FIG. 4 is an exemplary and schematic cross-sectional view of the lid of the battery of the first embodiment, with a liquid inlet opened;

FIG. 5 is an exemplary and schematic cross-sectional view of the lid of the battery of the first embodiment, with the liquid inlet closed by a first lid;

FIG. 6 is an exemplary and schematic plan view of a battery of a second embodiment;

FIG. 7 is an exemplary and schematic plan view of the battery of the second embodiment, with a liquid inlet closed by a first lid;

FIG. 8 is an exemplary and schematic plan view of a battery of a third embodiment;

FIG. 9 is an exemplary and schematic cross-sectional view of a lid of the battery of the third embodiment, with one of two liquid inlets closed by a first lid;

FIG. 10 is an exemplary and schematic cross-sectional view of the lid of the battery of the third embodiment, with the other of the two liquid inlets opened;

FIG. 11 is an exemplary and schematic cross-sectional view of the lid of the battery of the third embodiment, with the other of the two liquid inlets closed by a first lid;

FIG. 12 is an exemplary and schematic plan view of a battery of a fourth embodiment;

FIG. 13 is an exemplary and schematic cross-sectional view of a lid of the battery of the fourth embodiment, with a liquid inlet closed by a first lid;

FIG. 14 is an exemplary and schematic cross-sectional view of the lid of the battery of the fourth embodiment, with a second valve opened;

FIG. 15 is an exemplary and schematic cross-sectional view of the lid of the battery of the fourth embodiment, with the second valve closed by a second lid;

FIG. 16 is an exemplary and schematic perspective view of a battery of a fifth embodiment;

FIG. 17 is an exemplary and schematic perspective view of the battery of a first modification of the fifth embodiment;

FIG. 18 is an exemplary and schematic perspective view of the battery of a second modification of the fifth embodiment; and

FIG. 19 is an exemplary and schematic perspective view of the battery of a third modification of the fifth embodiment.

### DETAILED DESCRIPTION

Exemplary embodiments of the present invention will be disclosed below. Elements of the embodiments described below, and actions and effects achieved by the elements are merely exemplary. Throughout this specification, ordinal numbers are used for distinguishing parts, components, or members alone, and not intended to indicate order or priority.

The embodiments disclosed below include similar or same constituent elements. Thus, the similar or same constituent elements are denoted by common reference numerals, and overlapping descriptions will be omitted. For the sake of convenience, three directions orthogonal to one another are defined in the following drawings. An X direction is along the thickness (longitudinal direction) of a battery 1, a Y direction along the width (lateral direction) of the battery 1, and a Z direction along the height (vertical direction) of the battery 1. In the following, positive X, Y, and Z directions (indicated by the arrow tip) are referred to as a first side, and negative X, Y, and Z directions as a second side.

### First Embodiment

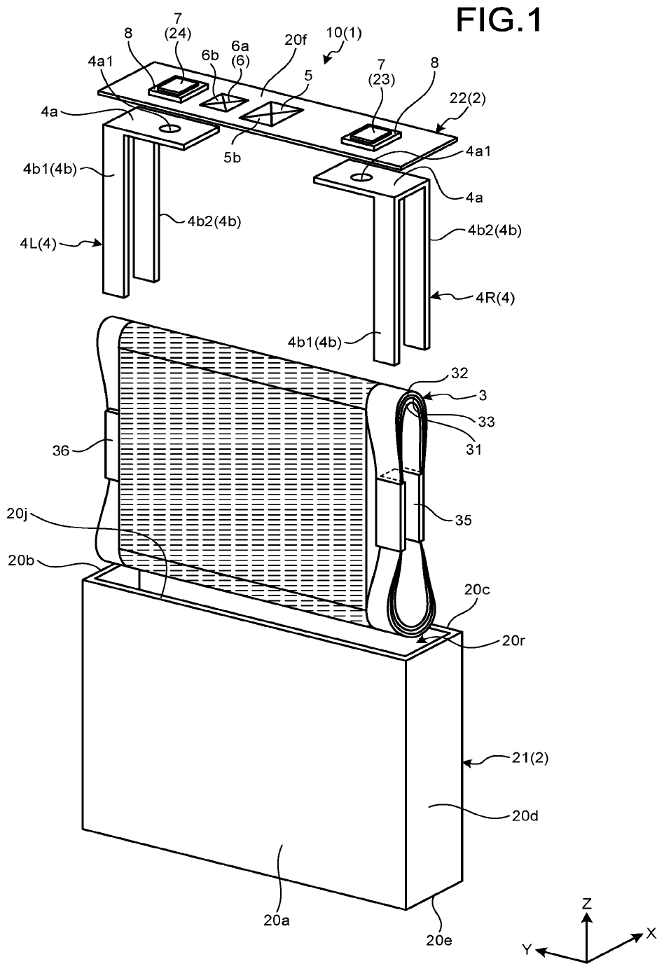

FIG. 1 is an exploded perspective view of the battery 1. As illustrated in FIG. 1, the battery 1 serves as, for example, a secondary battery (a storage battery, a rechargeable battery), and includes a housing 2, an electrode 3, conductive members 4, a pressure release valve 5, a liquid inlet 6, and external connection terminals 7. The battery 1 may also be referred to as a cell, a battery cell, or a can cell, and the housing 2 as a container or a casing. The electrode 3 may be also referred to as an electrode group, a power storage, a coil unit, or a charger/discharger, and the conductive members 4 as lead members, connection members, or terminal members.

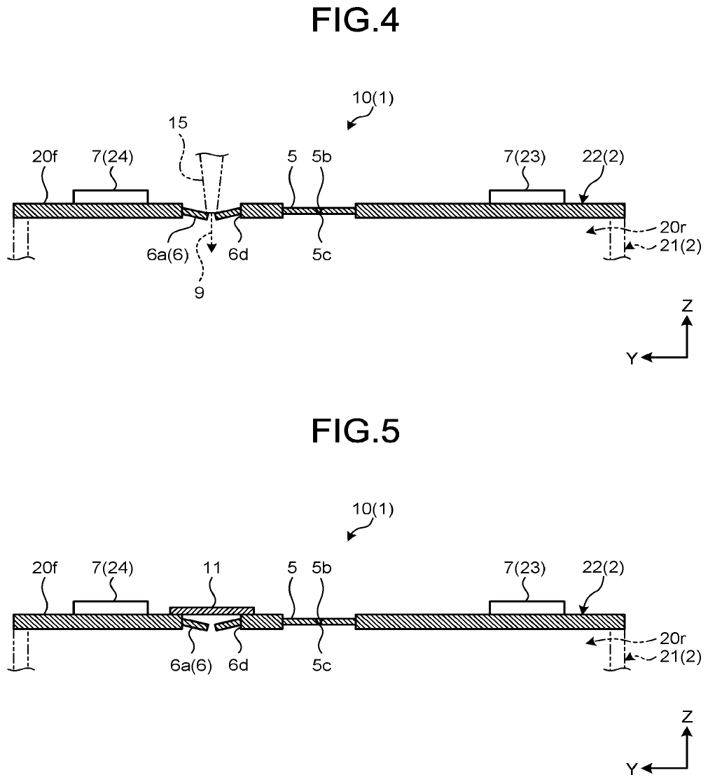

The battery 1 can include a lithium-ion secondary battery, for example. The battery 1 may be another secondary battery such as a nickel-hydrogen battery, a nickel-cadmium battery, and a lead storage battery. The lithium-ion secondary battery is a type of nonaqueous electrolyte secondary battery, and lithium ions in the electrolyte are electrically conductive. Examples of a positive electrode material include a lithium-manganese composite oxide, a lithium-nickel composite oxide, a lithium-cobalt composite oxide, a lithium-nickel-cobalt composite oxide, a lithium-manganese-cobalt composite oxide, a spinel-type lithium-manganese-nickel composite oxide, and a lithium phosphorus oxide with an olivine structure. Examples of a negative electrode material include an oxide-based material such as lithium titanate (LTO) and an oxide material such as a niobium composite oxide. Examples of an electrolytic solution 9 (see FIG. 4) includes sole or a mixture of organic solvents such as ethylene carbonate, propylene carbonate, diethyl carbonate, ethyl methyl carbonate and dimethyl carbonate, into which a lithium salt such as a fluorine complex salt (e.g., LiBF4, LiPF6) is mixed.

As illustrated in FIG. 1, the housing 2 has, for example, a thin, flat rectangular parallelepiped shape in the X direction. The housing 2 has a plurality of walls 20a to 20f. Both of the walls 20a and 20c extend in a direction orthogonal to the X direction (YZ plane), and stand in parallel with spacing in the X direction. Both of the walls 20b and 20d extend in a direction orthogonal to the Y direction (XZ plane), and stand in parallel with spacing in the Y direction. The walls 20a to 20d are referred to as, for example, sidewalls or peripheral walls.

Both of the walls 20e and 20f extend in a direction orthogonal to the Z direction (XY plane), and stand in parallel with spacing in the Z direction. The wall 20e is referred to as, for example, a bottom wall or a lower wall, and the wall 20f as, for example, a top wall or an upper wall. The wall 20f is provided with external connection terminals 7. The wall 20f is an exemplary first wall.

The housing 2 includes a combination of parts and components (divided elements). Specifically, the housing 2 includes, for example, a case 21 and a lid 22. The case 21 has at least the walls 20a to 20e. The case 21 is provided with a chamber 20r serving as an opening surrounded by the walls 20a to 20e and opened in the first side of the Z direction. The chamber 20r accommodates the electrode 3, the conductive members 4, and the electrolytic solution 9 (see FIG. 4). The case 21 is also referred to as, for example, a container, a lower case, or a first housing member.

The lid 22 has at least the wall 20f. The lid 22 is united with the case 21 while covering the chamber 20r. The lid 22 is joined to an upper end 20j of the case 21 by, for example, welding so as to prevent liquids or gases from leaking from the joint. The lid 22 is also referred to as, for example, a cover, an upper case, a closing plate, or a second housing member. The housing 2 is formed of, for example, a metal material such as aluminum.

The external connection terminals 7A, i.e., a positive electrode terminal 23 and a negative electrode terminal 24 are exposed to the outer surface of the lid 22. The positive electrode terminal 23 and the negative electrode terminal 24 are spaced apart from each other in the Y direction. The lid 22 is provided with the liquid inlet 6 and the pressure release valve 5, as described later, between the positive electrode terminal 23 and the negative electrode terminal 24.

The positive electrode terminal 23 is coupled to a positive electrode lead 4R being one of the conductive members 4 inside the lid 22, penetrating the lid 22 (the wall 20f). The negative electrode terminal 24 is coupled to a negative electrode lead 4L being the other of the conductive members 4 inside the lid 22, penetrating the lid 22. The lid 22 is provided with insulating members 8 between the positive electrode terminal 23 and the wall 20f and between the negative electrode terminal 24 and the wall 20f. The insulating members 8 serve to individually insulate between the lid 22 and the external connection terminals 7. In the present embodiment, the lid 22 is provided with only two openings (through holes, not illustrated) into which the positive electrode terminal 23 and the negative electrode terminal 24 are inserted. There are no other openings.

The electrode 3 includes, for example, a positive electrode 31, a negative electrode 32, and an insulating layer 33 (separator). The positive electrode 31, the negative electrode 32, and the insulating layer 33 are all in the form of a sheet. The electrode 3 has a flat shape including the sheet-like positive electrode 31, negative electrode 32, and insulating layer 33 folded or wound around an axis in the Y direction. The electrode 3 is an electrode group and functions as a power generation element.

Each of the positive electrode 31 and the negative electrode 32 includes a collector, an active material layer covering the collector, and a collector tab projecting from the collector. The collector tab of the positive electrode 31 is located at a second end of the electrode 3 in the Y direction and connected to a positive electrode backup lead 35 illustrated in FIG. 1. The collector tab of the negative electrode 32 is located at a first end of the electrode 3 in the Y direction and connected to a negative electrode backup lead 36. The positive electrode backup lead 35 and the negative electrode backup lead 36 are also referred to as, for example, lead members, conductive members, connection members, or terminal members.

The positive electrode lead 4R is electrically connected to the positive electrode 31 and the positive electrode terminal 23 via the positive electrode backup lead 35. The positive electrode lead 4R and the positive electrode terminal 23 are coupled together by, for example, crimping. The positive electrode lead 4R and the positive electrode backup lead 35 are coupled together by, for example, ultrasonic welding.

The negative electrode lead 4L is electrically connected to the negative electrode 32 and the negative electrode terminal 24 via the negative electrode backup lead 36. The negative electrode lead 4L and the negative electrode terminal 24 are coupled together by, for example, crimping. The negative electrode lead 4L and the negative electrode backup lead 36 are coupled together by, for example, ultrasonic welding.

Each conductive member 4 includes, for example, a base 4a and an arm 4b. The base 4a has a quadrangular plate shape extending along the lid 22. The lid 22 is placed on the top of the base 4a with an insulating sheet held therebetween inside the lid 22, for example. The base 4a is provided with a through hole 4a1 into which the external connection terminal 7 is inserted. Each conductive member 4 is formed of one plate member bent at two locations (the base of the arm 4b), for example.

The arm 4b has a quadrangular plate shape extending along the walls 20a and 20c. The arm 4b includes a first arm 4b1 and a second arm 4b2. The first arm 4b1 and the second arm 4b2 individually project from the base 4a in the second side of the Z direction, and are spaced apart from each other in the X direction. Each conductive member 4 is coupled to the positive electrode backup lead 35 or the negative electrode backup lead 36 of the electrode 3 with an end (the collector tab) of the electrode 3 held between the first arm 4b1 and the second arm 4b2.

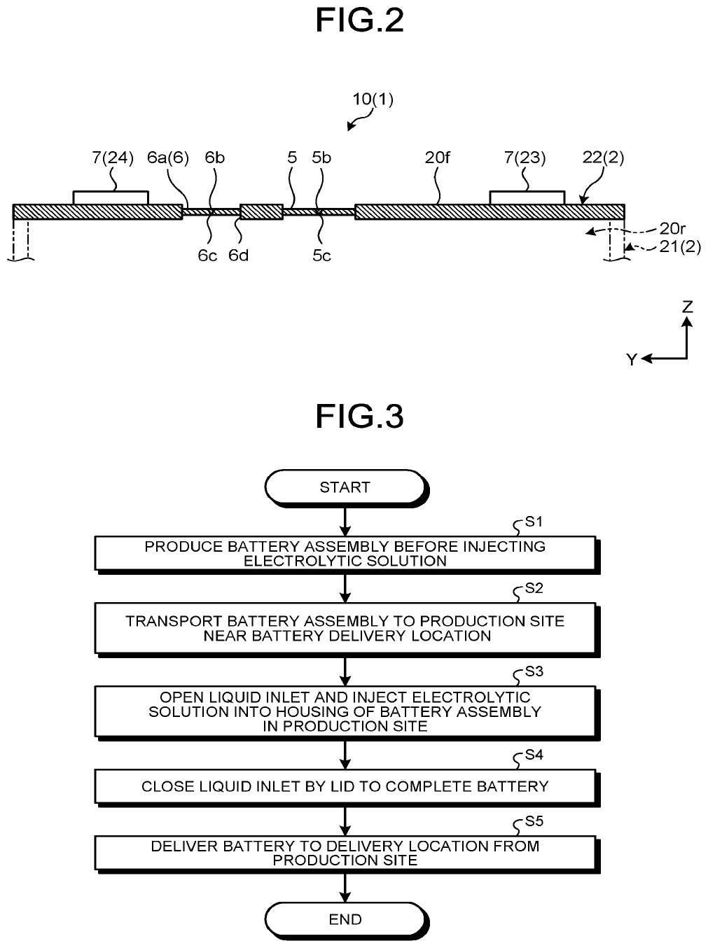

FIG. 2 is a cross-sectional view of the lid 22. As illustrated in FIG. 2, the lid 22 is provided with the liquid inlet 6 and the pressure release valve 5. The liquid inlet 6 and the pressure release valve 5 are aligned with spacing in the Y direction. In other words, the lid 22 is provided with the liquid inlet 6 and the pressure release valve 5 separately. The pressure release valve 5 is located between the positive electrode terminal 23 and the negative electrode terminal 24, and the liquid inlet 6 is located between the pressure release valve 5 and the negative electrode terminal 24. In the present embodiment, the liquid inlet 6 and the pressure release valve 5 have substantially the same shape. That is, the specifications of the liquid inlet 6 are substantially the same as those of the pressure release valve 5.

Specifically, the liquid inlet 6 includes a valve 6a. The valve 6a is formed by, for example, partially thinning the thickness of the lid 22 (the wall 20f) in the Z-direction. The thickness of the valve 6a is about half the thickness of the lid 22. The valve 6a is provided with openings 6d (depressions) on the outer surface and the inner surface. In other words, the valve 6a is located in an opening 6d (through hole) of the lid 22, closing the opening 6d. The valve 6a has a quadrangular shape smaller than the pressure release valve 5, as viewed in the Z direction (see FIG. 1). The valve 6a is an exemplary first valve. The valve 6a may have the same size as the pressure release valve 5.

As illustrated in FIG. 2, the valve 6a is also provided with a groove 6b. The groove 6b is recessed from the outer surface toward the inner surface of the valve 6a, that is, to the second side of the Z direction, and is opened in the first side of the Z direction. The groove 6b extends radially from the center of the valve 6a. The groove 6b has an X-shape as viewed in the Z direction.

The groove 6b includes a fragile part 6c (see FIG. 2) in the bottom. That is, the fragile part 6c is a thin-thickness part of the valve 6a due to the groove 6b. The fragile part 6c is also referred to as, for example, a thin-thickness part or a deformable part. The valve 6a works to open the inside of the housing 2, that is, the chamber 20r by breaking the fragile part 6c, so as to allow injection of the electrolytic solution 9 (see FIG. 4).

The pressure release valve 5a is provided with a groove 5b and a fragile part 5c similar to the groove 6b and the fragile part 6c of the valve 6a. The pressure release valve 5 is opened to lower a pressure within the housing 2 when the pressure exceeds a threshold value. The pressure release valve 5 is pressed and opened from inside to outside the housing 2 by breaking the fragile part 5c.

Next, a manufacturing method for the battery 1 will be described. FIG. 3 is a flowchart of a manufacturing method for the battery 1. FIGS. 4 and 5 are cross-sectional views of the lid 22. FIG. 4 illustrates the lid 22 with the liquid inlet 6 opened, and FIG. 5 illustrates the same with the liquid inlet 6 closed by a sealing lid 11. The sealing lid 11 is an exemplary first lid.

As illustrated in FIG. 3, a battery assembly 10 is produced first before injecting the electrolytic solution 9 into the battery 1 (S1). S1 includes, for example, producing a lid assembly by uniting the lid 22, the external connection terminals 7, the conductive members 4 (see FIG. 1), and the electrode 3 together, inserting the electrode 3 and the conductive members 4 of the lid assembly into the chamber 20r of the case 21, and uniting the lid 22 of the lid assembly and the case 21 by welding.

Subsequently, the battery assembly 10 is transported to a production site near a delivery location of the battery 1, as illustrated in FIG. 3 (S2). To transport the battery 1 including the electrolytic solution 9 abroad, it may take time and cost to pack the battery 1 for the purpose of safety enhancement. In this respect, according to the present embodiment, the battery 1 having no the electrolytic solution 9 injected, that is, the battery assembly 10 is transported, resulting in reduction of time and cost for packing.

As illustrated in FIGS. 3 and 4, the liquid inlet 6 is opened to inject the electrolytic solution 9 into the housing 2 of the battery assembly 10 in the production site (S3). The liquid inlet 6 can be torn open by, for example, pressing the distal end of a nozzle 15 of an electrolytic solution injecting device thereto. The valve 6a of the liquid inlet 6 is thereby pressed and opened from the outside to the inside of the housing 2 to allow the opening 6d to be at least partially in communication. A given amount of the electrolytic solution 9 sufficient to immerse the electrode 3 (see FIG. 1) is injected into the housing 2 from the opening 6d.

Subsequently, the liquid inlet 6 is closed by the sealing lid 11 from the exterior of the housing 2, completing the battery 1, as illustrated in FIGS. 3 and 5 (S4). The sealing lid 11 is placed upon the outer surface of the lid 22 around the peripheral edge of the liquid inlet 6. The sealing lid 11 is formed of, for example, a metal material such as aluminum, and can be joined to the lid 22 by laser welding or crimping.

The battery 1 is delivered to the delivery location from the production site (S5). As described above, according to the present embodiment, the battery 1 can be manufactured in the production site closer to the delivery location. This can reduce a period of time from the completion of the battery 1 to start of use, for example, leading to preventing degradation or variation in the performance of the battery 1. Further, facility costs of the production site can be lowered, as compared with manufacture of the battery 1 from the beginning in the production site near the delivery location.

As described above, in the present embodiment, for example, the battery assembly 10 includes the pressure release valve 5 and the liquid inlet 6. The pressure release valve 5 is located in the wall 20f (first wall) of the housing 2 to be opened in response to a rise in pressure inside the housing 2. The liquid inlet 6 is separated from the pressure release valve 5 in the wall 20f, includes the fragile part 6c, and serve to open the inside of the housing 2 by breaking the fragile part 6c so as to allow injection of the electrolytic solution 9. Owing to such a structure, for example, using the battery assembly 10 results in reducing transportation costs and the facility costs of the production site and attaining the battery 1 with less degradation or variation in performance, for example. It is also possible to ensure prevention of water drops or dust from entering the housing 2 as compared with battery 1 with a liquid inlet sealed by a seal member for transportation.

Moreover, in the present embodiment, the liquid inlet 6 has the same shape as the pressure release valve 5, for example. Owing to such a structure, for example, the liquid inlet 6 can be relatively easily formed, resulting in reduction of time and cost for manufacturing the battery 1.

In the present embodiment, for example, the liquid inlet 6 includes the valve 6a (first valve), and the valve 6a is pressed and opened from the outside to the inside of the housing 2 by breaking the fragile part 6c. Owing to such a structure, for example, the liquid inlet 6 that opens the inside of the housing 2 to allow injection of the electrolytic solution 9 can be formed by pressing and opening the valve 6a from the outside to the inside of the housing 2.

### Second Embodiment

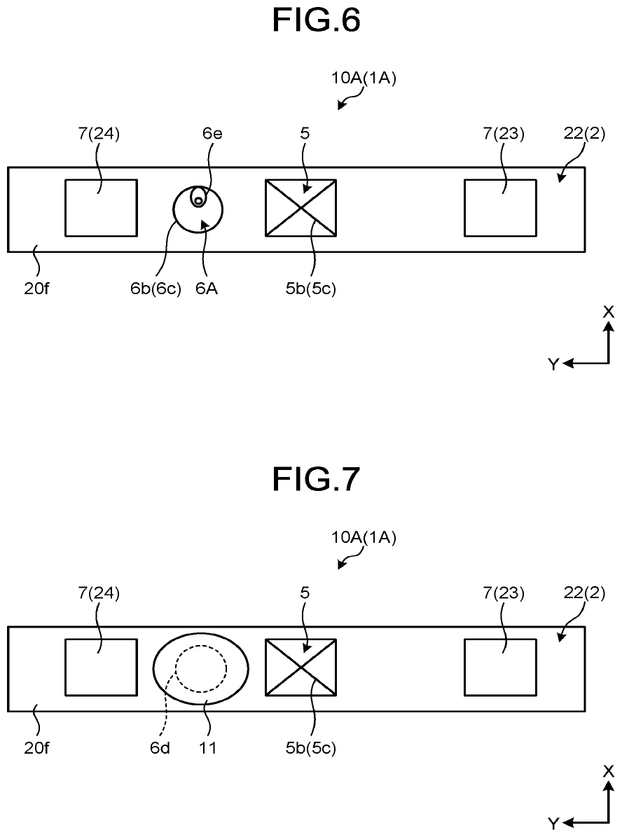

FIG. 6 is a plan view of a battery 1A, and FIG. 7 is a plan view of the battery 1A with a liquid inlet 6A closed by the sealing lid 11. The battery 1A and a battery assembly 10A of an embodiment illustrated in FIGS. 6 and 7 include elements similar to those of the battery 1 and the battery assembly 10 of the first embodiment. Thus, the present embodiment also achieves similar effects based on the elements similar to those of the first embodiment.

However, the present embodiment differs from the first embodiment in that the liquid inlet 6A serves as a pull-tab easy open end, for example, as illustrated in FIG. 6. The liquid inlet 6A includes, in the peripheral edge, a fragile part 6c with a thinner thickness due to a groove 6b. The circular groove 6b (the fragile part 6c) is also provided with a tab 6e inside. In the present embodiment, the fragile part 6c is broken by pulling the tab 6e of the liquid inlet 6A to form an opening 6d (see FIG. 7) penetrating the lid 22. The electrolytic solution 9 (see FIG. 4) can be thereby injected into the housing 2 from the opening 6d. As illustrated in FIG. 7, the opening 6d is closed by the sealing lid 11 from the outside of the housing 2 after injection of the electrolytic solution 9. According to the present embodiment, thus, the liquid inlet 6A that opens the inside of the housing 2 so as to allow injection of the electrolytic solution 9 can be formed by the easy open end.

### Third Embodiment

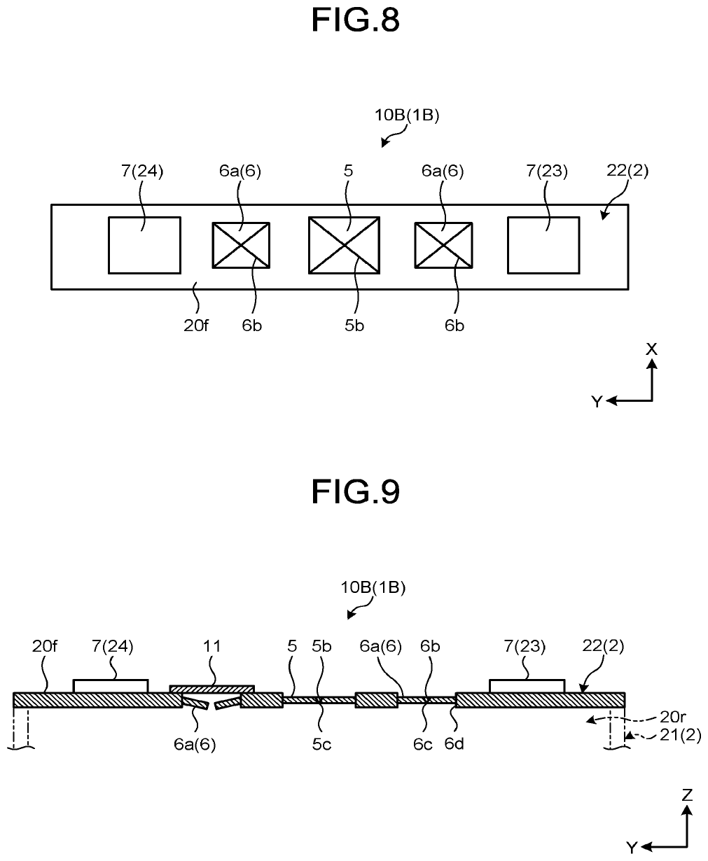

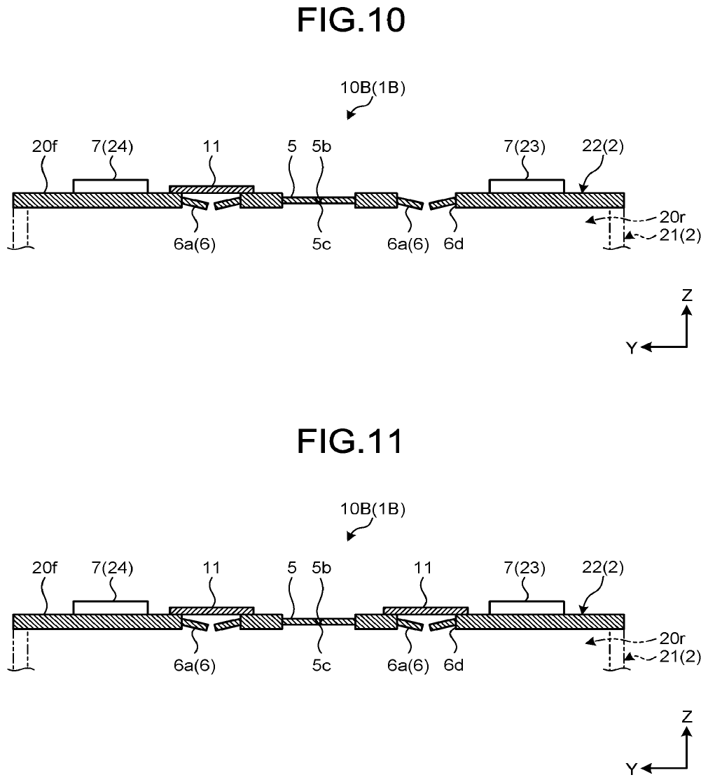

FIG. 8 is a plan view of a battery 1B. FIGS. 9 to 11 are cross-sectional views of a lid 22 of the battery 1B. FIG. 9 illustrates the lid with one of two liquid inlets 6 closed by the sealing lid 11, FIG. 10 illustrates the same with the other of the two liquid inlets 6 opened, and FIG. 11 illustrates the same with the other of the two liquid inlets 6 closed by the sealing lid 11. The battery 1B and a battery assembly 10B of an embodiment illustrated in FIGS. 8 to 11 include elements similar to those of the battery 1 and the battery assembly 10 of the first embodiment. Thus, the present embodiment also achieves similar effects based on the elements similar to those of the first embodiment.

However, the present embodiment differs from the first embodiment in that the lid 22 is provided with a plurality of liquid inlets 6, for example, as illustrated in FIG. 8. In the present embodiment, one of the liquid inlets 6 is located between the pressure release valve 5 and the negative electrode terminal 24, and the other is located between the pressure release valve 5 and the positive electrode terminal 23. The two liquid inlets 6 are aligned with spacing in the Y direction. The liquid inlets 6 have the same shape and the same specifications as each other. According to the present embodiment, for example, the two liquid inlets 6 in the lid 22 can improve the degree of freedom of injecting work for the electrolytic solution 9, resulting in further reducing time and labor for manufacturing the battery 1B. In addition one of the two liquid inlets 6 can be advantageously used as a gas vent valve after aging of the battery 1B, for example.

Specifically, in the present embodiment, one of the two liquid inlets 6 is opened to inject the electrolytic solution 9 into the housing 2, and the liquid inlet 6 is then closed by the sealing lid 11 at S3 and S4 as illustrated in FIG. 9. In this state the battery 1B is charged and subjected to aging. The other of the two liquid inlets 6 is next opened as illustrated in FIG. 10 to discharge a gas occurring due to the aging inside the housing 2 (the chamber 20r) from the opening 6d to outside. The liquid inlet 6 is closed by the other of the two sealing lids 11, completing the battery 1B as illustrated in FIG. 11. According to the present embodiment, thus, the battery can be released from gas after aging through one of the liquid inlets 6. This can improve the initial performance of the battery 1B, for example.

### Fourth Embodiment

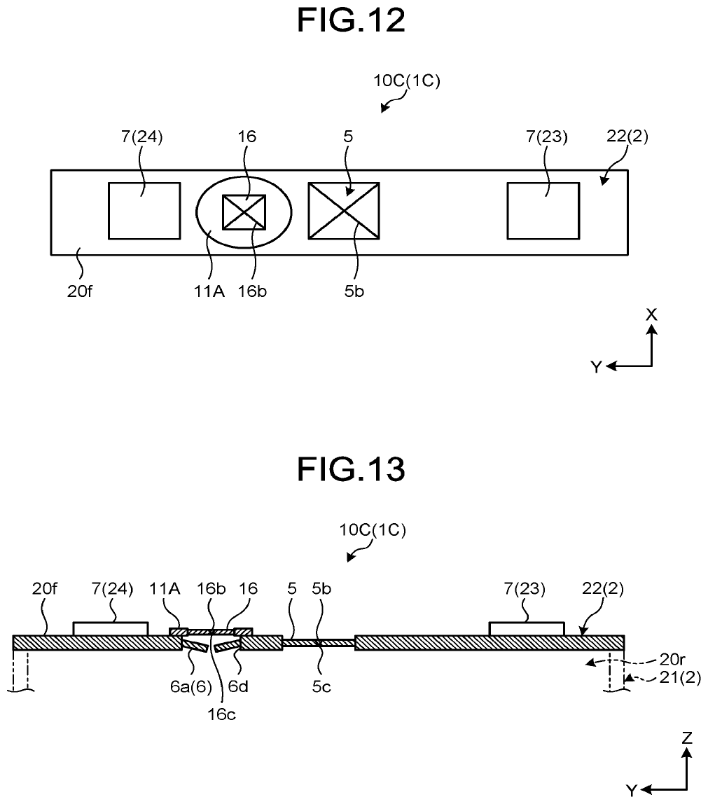

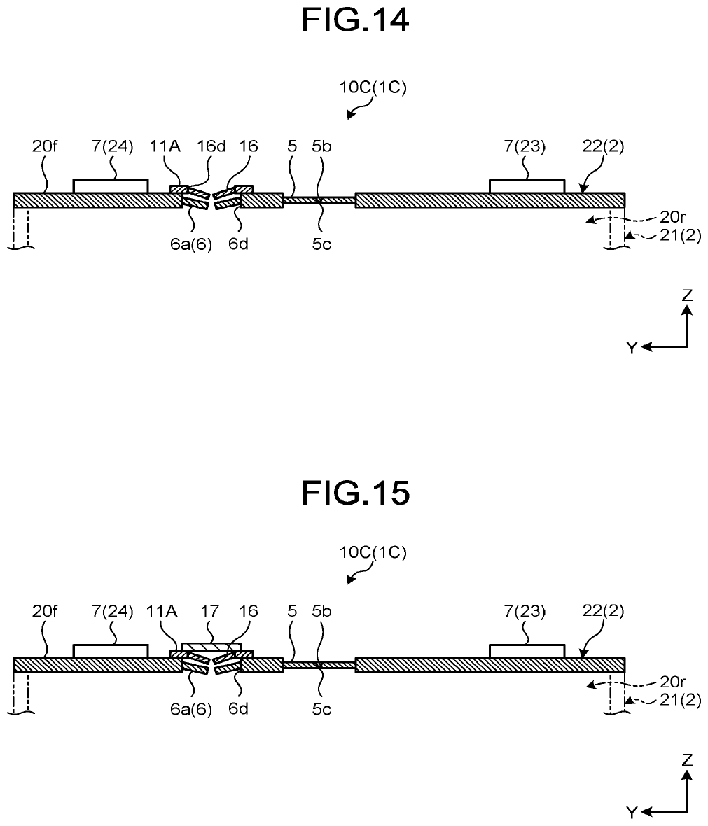

FIG. 12 is a plan view of a battery 1C. FIGS. 13 to 15 are cross-sectional views of a lid 22 of the battery 1C. FIG. 13 illustrates the lid with the liquid inlet 6 closed by a sealing lid 11A, FIG. 14 the lid with a valve 16 opened, and FIG. 15 the lid with the valve 16 closed by a sealing lid 17. The battery 1C and a battery assembly 10C of an embodiment illustrated in FIGS. 12 to 15 include elements similar to those of the battery 1 and the battery assembly 10 of the first embodiment. Thus, the present embodiment also achieves similar effects based on the elements similar to those of the first embodiment.

However, the present embodiment differs from the first embodiment in that the sealing lid 11A is provided with a valve 16, for example, as illustrated in FIGS. 12 and 13. The valve 16 has substantially the same shape and the same specifications as the liquid inlet 6 and the pressure release valve 5. That is, the valve 16 includes a fragile part 16c with a thinner thickness due to a groove 16b. As illustrated in FIG. 14, the valve 16 can be torn open by, for example, pressing the distal end of a jig thereto. The valve 16 is thereby pressed and opened from the outside to the inside of the housing 2 to allow an opening 16d to be at least partially in communication. The valve 16 is an exemplary second valve. As described above, according to the present embodiment, the valve 16 in the sealing lid 11A can be used as, for example, a gas vent valve after aging of the battery 1C.

Specifically, in the present embodiment, the battery 1C is charged and subjected to aging while the housing 2 is sealed with the liquid inlet 6 closed by the sealing lid 11A, as illustrated in FIG. 13. As illustrated in FIG. 14, the valve 16 in the sealing lid 11A is then opened to discharge an accumulated gas due to aging from the housing 2 (the chamber 20r) through the opening 16d. The valve 16 is closed by the sealing lid 17 from the outside of the housing 2, that is, opposite to the liquid inlet 6, completing the battery 1C, as illustrated in FIG. 15. The sealing lid 17 is an exemplary second lid.

### Fifth Embodiment

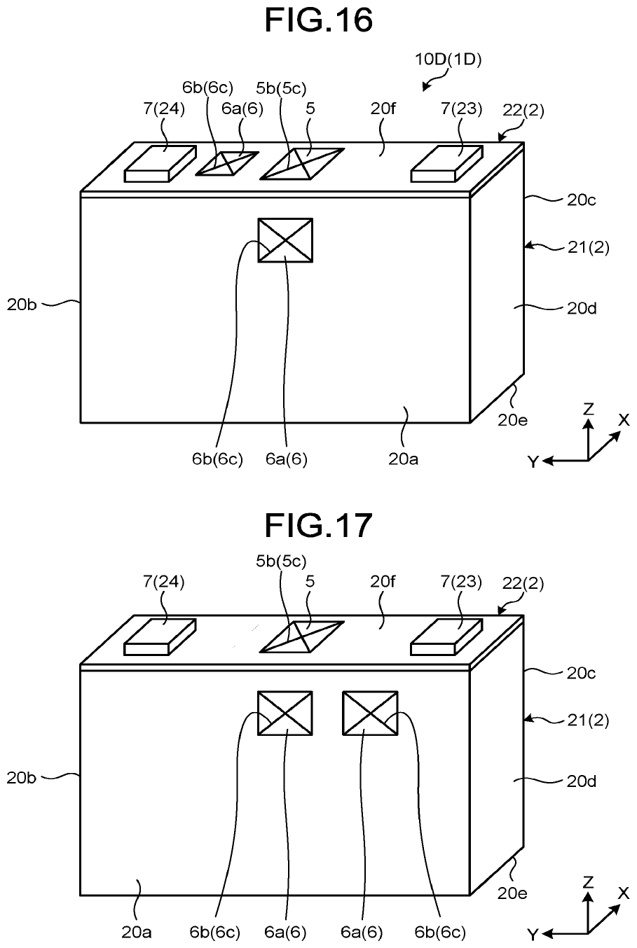

FIG. 16 is a perspective view of a battery 1D. The battery 1D and a battery assembly 10D of an embodiment illustrated in FIG. 16 include elements similar to those of the battery 1 and the battery assembly 10 of the first embodiment. Thus, the present embodiment also achieves similar effects based on the elements similar to those of the first embodiment.

However, the present embodiment differs from the first embodiment in that the lid 22 and the case 21 are both provided with the liquid inlet 6, for example, as illustrated in FIG. 16. In the present embodiment, one of the two liquid inlets 6 is located between the pressure release valve 5 and the negative electrode terminal 24 of the lid 22 (the wall 20f), and the other is located in the wall 20a of the case 21. The wall 20f is an exemplary first wall, and the wall 20a is an exemplary second wall. Thus, according to the present embodiment, for example, the two liquid inlets 6 in the housing 2 can improve the degree of freedom of injecting work of the electrolytic solution 9, resulting in further reducing time and labor for manufacturing the battery 1D. For example, one of the two liquid inlets 6 can be used as a gas vent valve after aging of the battery 1D.

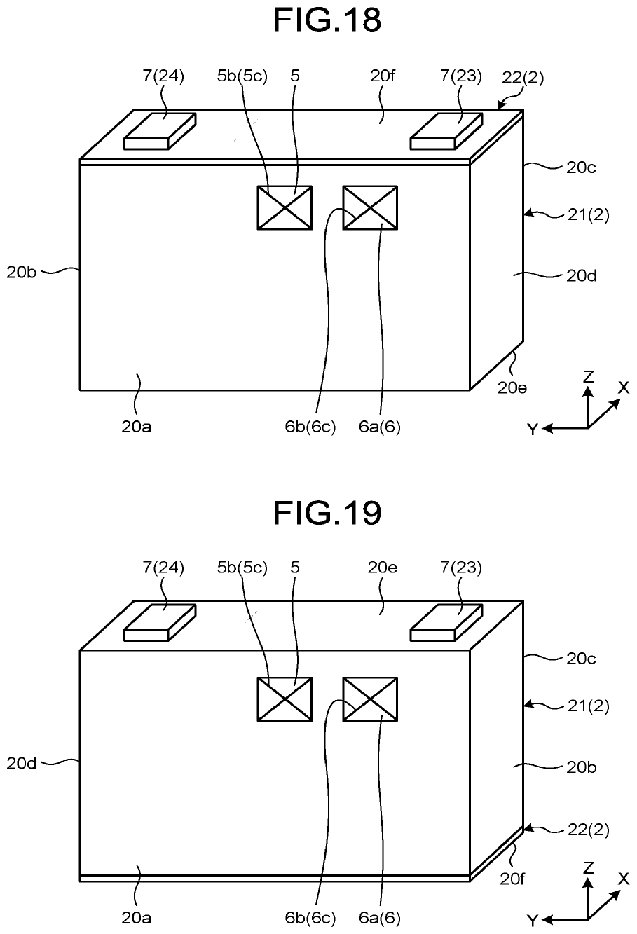

The present embodiment has described the example that the lid 22 and the case 21 are provided with the liquid inlets 6, however, it is not limited to such an example. As in a first modification illustrated in FIG. 17, for example, the case 21 may be provided with the liquid inlets 6. The two liquid inlets 6 are spaced apart from each other in the Y direction in the wall 20a of the case 21. For another example, as in a second modification illustrated in FIG. 18, the case 21 may be provided with the pressure release valve 5 and the liquid inlet 6. The pressure release valve 5 and the liquid inlet 6 are aligned with spacing in the Y direction in the wall 20a of the case 21. For another example, as in a third modification illustrated in FIG. 19, the case 21 may be equipped with the positive electrode terminal 23 and the negative electrode terminal 24. The positive electrode terminal 23 and the negative electrode terminal 24 are aligned with spacing in the Y direction in the wall 20e of the case 21. The wall 20e is an exemplary first wall.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. The present invention can be achieved by configurations other than those disclosed in the above embodiments, and can provide various effects (including derivative effects) obtained by the basic configurations (technical features). Furthermore, the specifications (structure, type, direction, shape, size, length, width, thickness, height, number, arrangement, position, and material) of each constituent element can be changed as appropriate.

1. A battery assembly having no electrolytic solution injected, the battery assembly comprising:
a housing that houses the electrolytic solution, the housing including
a first wall to which an external connection terminal is exposed, and
a second wall intersecting with the first wall;
an electrode housed in the housing and electrically connected to the external connection terminal;
a pressure release valve located in the first wall or the second wall, and to be opened in response to a rise in pressure inside the housing; and
a liquid inlet separately provided from the pressure release valve in at least one of the first wall and the second wall, the liquid inlet including a fragile part, to open an inside of the housing by breaking the fragile part to allow injection of the electrolytic solution.

2. The battery assembly according to claim 1, wherein
the liquid inlet has the same shape as the pressure release valve.

3. The battery assembly according to claim 1, wherein
the liquid inlet includes a first valve, and
the first valve is pressed and opened from an outside to the inside of the housing by breaking the fragile part.

4. The battery assembly according to claim 1, wherein
the first wall or the second wall is provided with a plurality of liquid inlets with spacing.

5. A battery comprising:
the battery assembly according to claim 1;
an electrolytic solution contained in a housing of the battery assembly; and
a first lid that closes a liquid inlet of the battery assembly from an outside of the housing.

6. The battery according to claim 5, wherein
the battery assembly is provided with a plurality of liquid inlets with spacing, and
the battery further comprises a plurality of first lids that individually close the liquid inlets.

7. The battery according to claim 5, wherein
the first lid includes a second valve, and
the second valve includes a fragile part, to open an inside of the housing by breaking the fragile part.

8. The battery according to claim 7, further comprising
a second lid that closes the second valve from an opposite side to the liquid inlets.

9. A lid to be included in a housing of a battery, the lid that closes a chamber that contains an electrolytic solution, the lid comprising:
a pressure release valve to be opened in response to a rise in pressure inside the chamber; and
a liquid inlet separated from the pressure release valve, the liquid inlet including a fragile part, to open an inside of the housing by breaking the fragile part to allow injection of the electrolytic solution.

10. A case to be included in a housing of a battery, the case provided with a chamber that contains an electrolytic solution, the case comprising
a liquid inlet including a fragile part, to open the chamber by breaking the fragile part to allow injection of the electrolytic solution.
